(19) United States
(12) Patent Application Publication
(10) Pub. No.: US 2011/0213679 A1
(43) Pub. Date: Sep. 1, 2011

(54) MULTI-QUANTITY FIXED PRICE REFERRAL SYSTEMS AND METHODS

(75) Inventors: Tsvetan Petkov, San Francisco, CA (US); Jean Qing Wong, Menlo Park, CA (US); Anthony Delvecchio, San Jose, CA (US); Didi Huang, Los Altos, CA (US); Steve Metz, San Francisco, CA (US); Jonathan Conradt, San Jose, CA (US)

(73) Assignee: eBay Inc., San Jose, CA (US)

(21) Appl. No.: 13/032,338

(22) Filed: Feb. 22, 2011

Related U.S. Application Data
(60) Provisional application No. 61/308,816, filed on Feb. 26, 2010.

(51) Int. Cl. G06Q 30/00

(52) U.S. Cl. 705/27.1

(57) ABSTRACT

Multi-quantity fixed price referral systems and methods are described. A “multi-quantity fixed price” listing is a listing published by an online publication system where a seller is selling a number of identical items for a fixed price for each of the items. The methods may include selecting a category from a catalogue hierarchy used by an online publication system. The selected category may be one of a plurality of categories assigned to listings each describing an item for sale. The listings within the selected category are filtered to select a set of filtered listings. A decay formula may be applied to each filtered listing of the set of filtered listings. One or more of the filtered listings are selected based on a ranking of the filtered listings. A graphical user interface to display the selected filtered listings to the user is provided.

This application claims the priority benefit of U.S. Provisional Application No. 61/308,816 filed Feb. 26, 2010 and entitled “Multi-Quantity Fixed Price Referral Tool,” which is incorporated herein by reference.

### TECHNICAL FIELD

The present application relates generally to the technical field of data management and, in one specific example, to systems and methods for a multi-quantity fixed price referral.

### BACKGROUND

In an online publication system, particular listings may be ranked in a set of search results and displayed to users based on a “sales per impression” metric that quantifies the number of times a user has purchased on item upon viewing the item in the online publication system.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment may be deployed.

FIG. 2 is a block diagram of an example referral system according to various embodiments.

FIG. 3 is a flowchart of an example technique performed by a referral system according to various embodiments.

FIG. 4 is a flowchart of an example technique for identifying categories according to various embodiments.

FIG. 5 is a block diagram of an example filter module to filter the listings according to various embodiments.

FIG. 6 shows a diagrammatic representation of machine in the example form of a computer system within which a set of instructions, for causing the machine to perform any one or more of the methodologies discussed herein, may be executed.

### DETAILED DESCRIPTION

Example methods and systems provide multi-quantity fixed price referrals are described. In the following description, for purposes of explanation, numerous specific details are set forth in order to provide a thorough understanding of example embodiments. It will be evident, however, to one skilled in the art that the present invention may be practiced without these specific details.

In an online publication system, where users may provide listings to be displayed to other users, some users may provide listings describing items or services for sale. To facilitate sales within the online publication system, a portion of the listings may be showcased to users at various locations (e.g., on a website or in a widget) associated with the online publication system. The showcased listings may be presented to users as, for example, “Great Deals” to encourage the users to purchase the item or service described in the listing. In some instances, the listings that are selected to be showcased are “multi-quantity fixed price” listings where a seller is selling a number of identical items for a fixed price for each of the items. For example, in a single listing, a seller may list 100 sprockets for $100 each that can be sold to one buyer or up to 100 separate buyers.

The listings describing items or services are categorized by the online publication system according to a predefined catalogue hierarchy. The categorization may be based on a specified category of the described item or service.

Some categories may account for a larger volume of sales than other categories or may contain more listings than other categories. To showcase a diverse selection of listings across several categories, it is desirable to identify categories by preserving the larger categories and combining smaller categories.

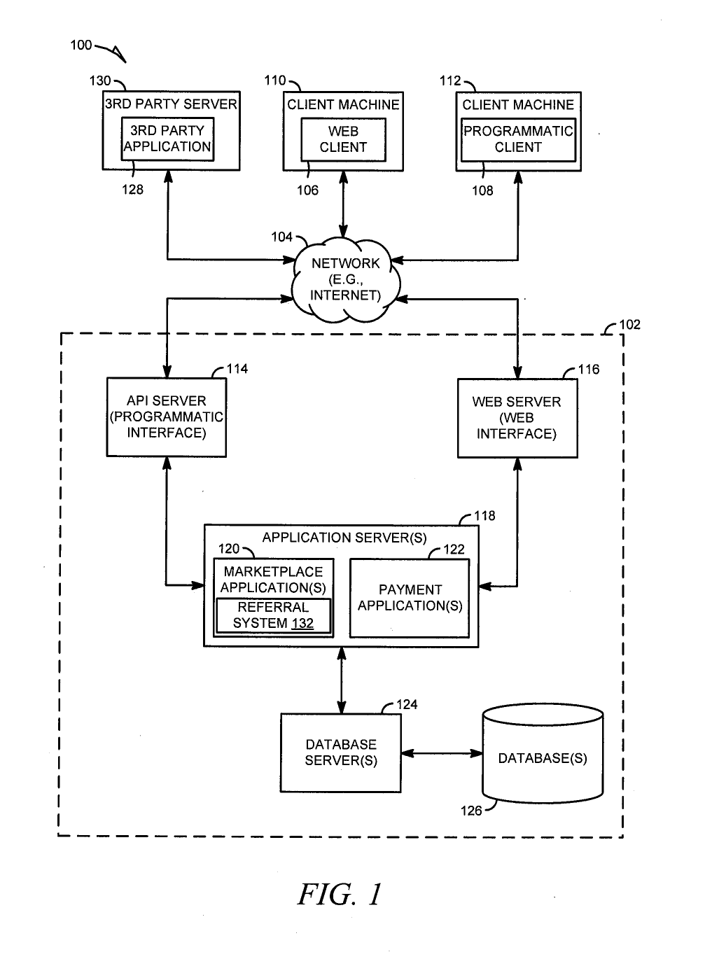

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or Wide Area Network (WAN)) to one or more clients. FIG. 1 illustrates, for example, a web client 106 (e.g., a browser, such as the Internet Explorer browser developed by Microsoft Corporation of Redmond, Wash. State), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of marketplace functions and services to users that access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. The marketplace applications may include, for example, a referral system 132. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments of the present invention is of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace or payment functions that are supported by the relevant applications of the networked system 102.

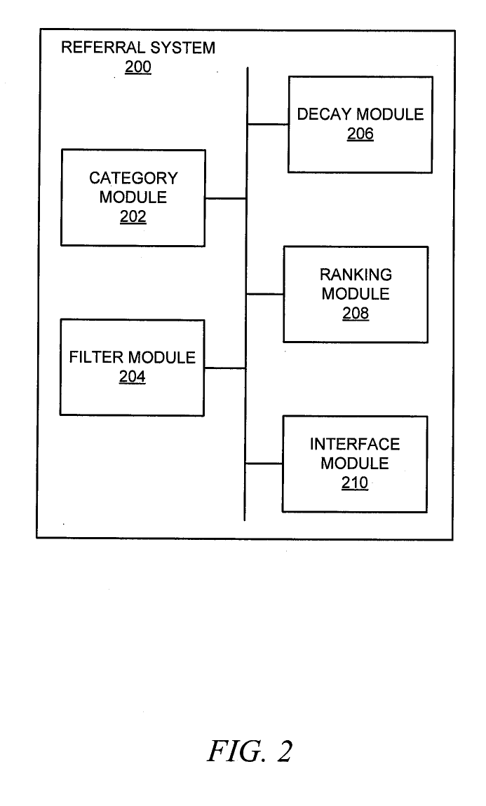

FIG. 2 is a block diagram of an example referral system 200 according to various embodiments. The referral system 200 may be implemented in hardware, software, or a combination thereof.

A category module 202 is configured to access a catalogue hierarchy from the online publication systems that is used by the online publication system to categorize listings that describe items or services. The catalogue hierarchy comprises a hierarchy having parent categories that may include a number of child categories. In some instances, a child category itself may include one or more child categories. Using the predefined catalogue hierarchy, the listings themselves may be assigned to child categories that do not include further child categories.

A category of a listing may refer to a parent category or to a child category within the catalogue hierarchy. For example, a parent category of a catalogue hierarchy may be “photography” and a child category may be “digital cameras.” As such, a listing describing an instance of a digital camera may be categorized as both “photography” and a “digital camera.”

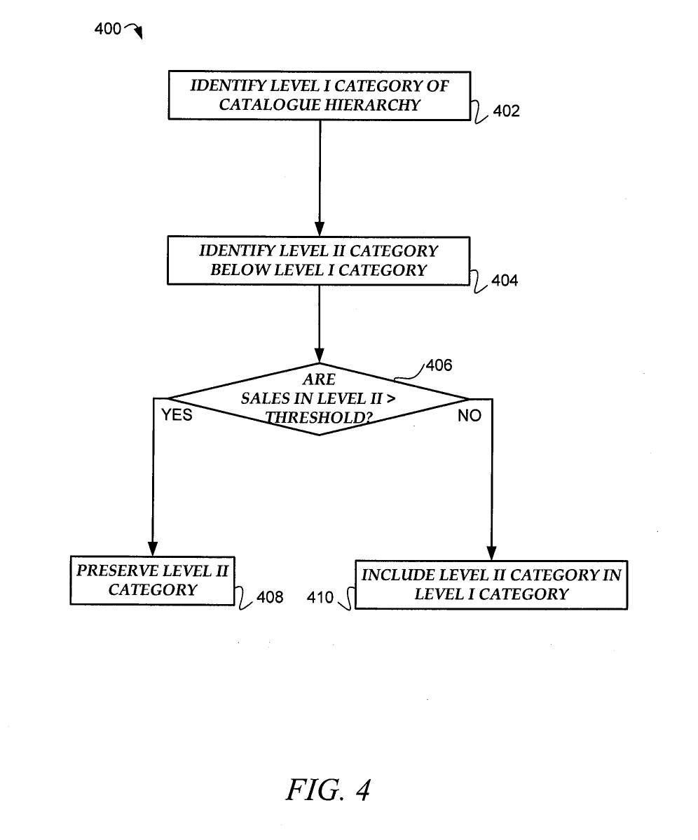

The category module 202 is further configured to select categories to be used by the referral system 200 without affecting the catalogue hierarchy itself. To showcase a diverse selection of listings across several categories, the referral system 200 may select categories by preserving certain categories and combining other categories. The category module 202 identifies one or more “level one” categories in the catalogue hierarchy. The level one categories are the categories that are not a child category of another category. Stated another way, the level one categories are the highest categories in the catalogue hierarchy. The level one categories respectively include one or more child categories, referred to as “level two” categories. As described in further detail in connection with FIG. 4, for each level one category, the sales in each level two category is compared to a threshold. If the threshold is met, the level two category is selected. If the threshold is not met, the level two category is combined with the other level two categories for the level one category that do not meet the threshold.

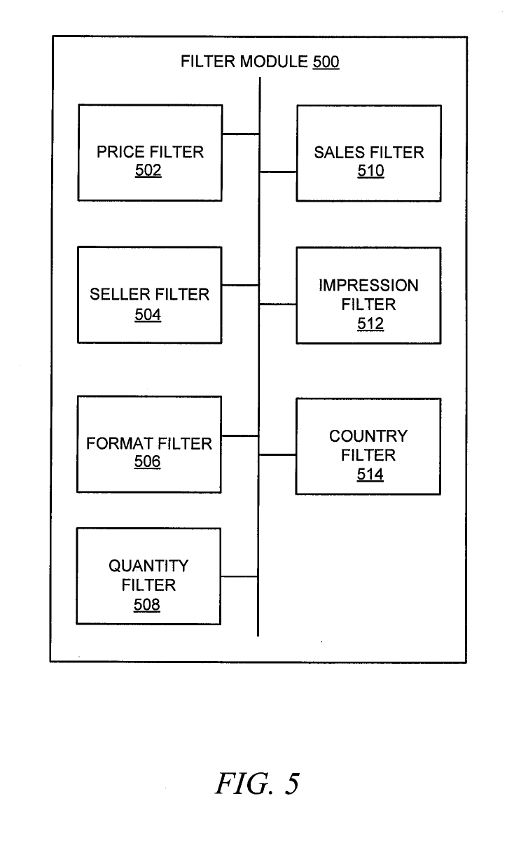

A filter module 204 is configured to filter the listings according to one or more factors using one or more filters. The filters may be applied to ensure that a diverse selection of listings across, for example, a price range is showcased without favoring low-priced or recently added listings. The filters may include, but are not limited to, price, seller reputation, sale format, quantity available for sale, a number of sales or impressions, and/or the country where the item is being sold. An example of the filter module 204 is discussed further in connection with FIG. 5.

A decay module 206 is configured to ensure that the listings are current by applying a decay formula to the listings in the filtered set of listings. The decay formula is applied to the number of sales or impressions associated with the listing to provide a discounted number of sales and a discounted number of impressions for each respective listing. An impression occurs when a user views the listing. The decay formula is used to discount the number of sales or impressions that occurred more than a pre-defined period of time in the past. The decay formula prevents listings for items that were once popular, but are no longer so popular, from being showcased.

The ranking module 208 is configured to rank the listings in the filtered set according to a ratio of the number of sales to the number of impressions. The ranking may be performed using the discounted number of sales and the discounted number of impressions. The listings within the identified categories corresponding to the highest ratio are then selected to be showcased to users of the online publication system.

The interface module 210 is configured to provide a graphical user interface to a user of the online publication system. The graphical user interface may display the selected filtered listings to the user. For example, the graphical user interface may include the selected filtered listings as a recommendation, a showcased item, or a “daily deal.” The provided graphical user interface may be a portion of a larger interface ultimately rendered to the user or may include additional elements.

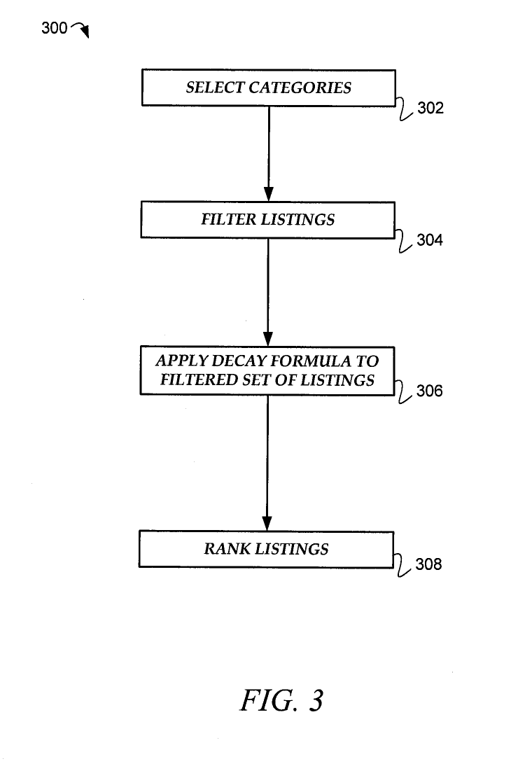

FIG. 3 is a flowchart of an example technique 300 performed by the referral system 200 according to various embodiments. The technique 200 is performed within the online publication system 102 to identify listings to be showcased to users of the online publication system 102. The technique 300 may be performed at a predefined interval or in response to a user input.

In an operation 302, one or more categories may be selected based on an existing hierarchy used by the online publication system 102 to categorize the items described in the listings. In some instances, the selection may be performed by the category module 202 within the referral system 200. One method of identifying the categories is described in FIG. 4.

Once the categories are identified, the listings are filtered to identify a filtered set of listings that are desirable for being showcased by the referral tool system 200, in an operation 304. An example filter module 204 may perform the filtering of operation 304 and is depicted in FIG. 5.

When the listings within a category (or across the categories) have been filtered to produce a filtered set of listings, a decay formula is applied to the respective listings in an operation 306. The operation 306 may be performed by the decay module 206 in the referral tool system 200. The decay formula is applied to the number of sales and/or the number of impressions associated with the listing (or re-listings of the listing) to calculate a discounted number of sales (or impressions). In some embodiments, the accumulated number of sales (or impressions) are decayed over time using the formula:

2̂(t/7)

where t is the age of each sale in days. As such, according to this formula, each sale is discounted by half in a week. The decay formula may be modified based on the number of sales (or impressions) in the category over a pre-defined period of time or other factors. The discounted number of sales and the discounted number of impressions may be useful where an item is popular for a short period of time such as an item associated with a popular movie or a holiday.

In an operation 308, the referral system 200 ranks listings in each category by its respective sales per impression ratio using the ranking module 208. The listings may be part of a filtered set of listings and/or be associated with a discounted number of sales or impressions as described in connection with operations 304 and 306. A listing, or a pre-defined quantity of the listings, associated with the highest sales per impression ratio within a category are selected to be showcased within the online publication system. For example, the predefined quantity of listings may be twenty listings within each category. This number may be adjusted based on, for example, the number of listings in the category or the velocity of sales within the category.

One or more ranking mechanisms may be applied by the ranking module 208 depending on characteristics of the buyer or the seller. In one example, the referral system 200 may showcase only those listings viewed or purchased from by top buyers if the user is a top buyer. A top buyer is identified based on a number of transactions or by a transaction volume in a given time period. In another example, the referral system 200 may operate to showcase a different number of items for each category depending on users' purchase history. For example, if a user searches the category “Clothing, Shoes, and Accessories” 90% of the time, the filters may showcase the top 20 items in that category, but only the top 5 items in other categories. In another instance, for sellers that mostly sell to top buyers, listings that are currently popular among these buyers may be showcased to these sellers. By doing so, these sellers can identify inventory to list in the online publication system. After the listings are ranked, one or more of the filtered listings are selected based, at least in part, on the ranking.

FIG. 4 is a flowchart of an example technique 400 for identifying categories according to various embodiments. The example technique may be used where the online publication system 102 includes a catalogue hierarchy. The catalogue hierarchy includes multiple levels where objects in higher levels (with level one being the highest) group objects in lower level categories. The technique 400 may be repeated for each lower level category within the level one categories of the catalogue hierarchy.

In an operation 402, a level one category of the catalogue hierarchy is identified. In one example, the catalogue hierarchy may include thirty to forty level one categories. The level one categories include, for example, “Camera and Photo,” “Cell Phones and PDAs,” “Health and Beauty,” and “Home and Garden.”

In an operation 404, a level two category below the level one category is identified. The catalogue hierarchy may include hundreds or thousands of level two categories, each associated with a level one category. To illustrate, the level one category, “Cameras and Photo” may include “Binoculars and Telescopes,” “Camcorders,” and “Digital Cameras.” For each identified level two category, operation 406 and operation 408 or 410 are performed. These operations may be repeated for level three categories and below, if desired.

In an operation 406, a determination whether the sales in the level two category account for more than a predetermined threshold (e.g., 0.4%) of total sales in the online publication system 102. The percentage of total sales may be modified based on various factors such as season, number of categories, total sales volume, and the like. As an example, the percentage of total sales may vary from 0.01% to 10%. The total sales may be calculated over a pre-defined period of time and based on overall number of sales, total revenue generated by the sales for the online publication system, total value of the sales, and other metrics.

In an operation 408, if the sales in the level two category exceed the predetermined threshold of total sales, the level two category is preserved within the referral system 200. To illustrate, if sales of items within the “digital cameras” in the level two category exceeds 0.4% of all sales in the online publication system, the level two category “Digital Cameras” (and the associated listings) is preserved separately from other categories for the purposes of the referral tool system. It is noted that the catalogue hierarchy itself is not affected.

If the sales in the level one category do not exceed the predetermined threshold of total sales, the level two category (and the listings associated with the level two category) is added to a general level one category. The general level one category and any preserved level two categories are not hierarchically related and may be stored as a flat data structure. To illustrate, if sales of items within the “binoculars and telescopes” in the level two category do not exceed 0.4% of all sales in the online publication system, the level two category “Binoculars and Telescopes” (and the associated listings) is rolled into a general level one category, “Cameras and Photo.” Similarly, if sales of items within “camcorders” in the level two category do not exceed 0.4% of all sales in the online publication system, the level two category “Camcorders” (and the associated listings) is rolled into the same general level one category, “Cameras and Photo” for ranking by the referral tool system. It is noted that the catalogue hierarchy itself remains unchanged.

The filtering of operation 304 may be performed by one or more filters within a filter module 500 shown in FIG. 5. The filter module 500 is an example of the filter module 204 of FIG. 2. The filter module 500 includes a number of filters such as a price filter 502, a seller filter 504, a format filter 506, a quantity filter 508, a sales filter 510, an impression filter 512, and a country filter 514.

The price filter 502 calculates an average price for each of the identified categories and excludes listings with prices below a defined price threshold (e.g., 30%) of the average price in each category. This price threshold may be varied based on one or more factors such as average price, distribution of prices within the category, and the number of items in the category. Setting an average price by category ensures that high priced items (which are purchased less frequently) can be showcased along with lower priced items (which are purchased more frequently) in the same category.

The seller filter 504 is used to exclude sellers that do not meet pre-defined seller thresholds. Sellers who provide the listings may be associated with a seller profile that includes qualitative and quantitative information (e.g., feedback) about past user experiences with the seller. Examples of information in the profile include reviews, ratings, reputation scores, complaints against the seller, and the like.

The format filter 506 excludes listings that are not multi-quantity fixed price or store inventory format live listings. Types of listings that may be excluded by the format filter 506 include auction listings, Dutch auction listings, reverse auction listings, single quantity fixed price listings, and listings not describing a particular item for sale. The format filter 506 further determines that, at the time the showcased listings are presented to the other users, the listings in the filtered set have not yet expired.

The quantity filter 508 excludes listings that indicate an available quantity of the item for sale that is less than a predefined quantity threshold (e.g., twenty items for sale). The available quantity threshold may vary based on price, average available quantity within the category, sales velocity, and other factors.

The sales filter 510 is used to exclude listings that have not yet sold a minimum number of items. A sales threshold may be static or may be dynamically adjusted based on, for example, the average price calculated by the price filter 502 or a percentage of the seller's inventory already sold. For example, an adjusted historical sales threshold for a listing may be calculated as:

3+(100/average price)

for a listing to be showcased. By adjusting the threshold based on the average price, high priced items (e.g., television sets) have a relatively lower sales floor than low priced items (e.g., cables). A total sales number or a discounted sales number (described above in connection with operation 206) may be compared to the sales threshold by the sales filter 510.

The impression filter 512 compares the total number of impressions of the listing (e.g., the number of times the listing was viewed by users in search results) to an impression threshold. The impression threshold may be at least 450 impressions, for example. The impression filter 512 may subtract or discount bot-generated impressions from the total number of impressions. The impression filter 512 may count impressions of re-listings of the listing towards this impression threshold. The impression threshold may be adjusted according to a number of factors including the number of impressions of other items in the same category. The threshold number of impressions may be compared to a total number of impressions or to a discounted number of impressions.

The country filter 514 is used to exclude listings posted from one or more countries. In some instances, the country filter 514 may exclude all listings except those posted from particular countries. In other embodiments, the country filter 514 may only exclude listings from particular countries.

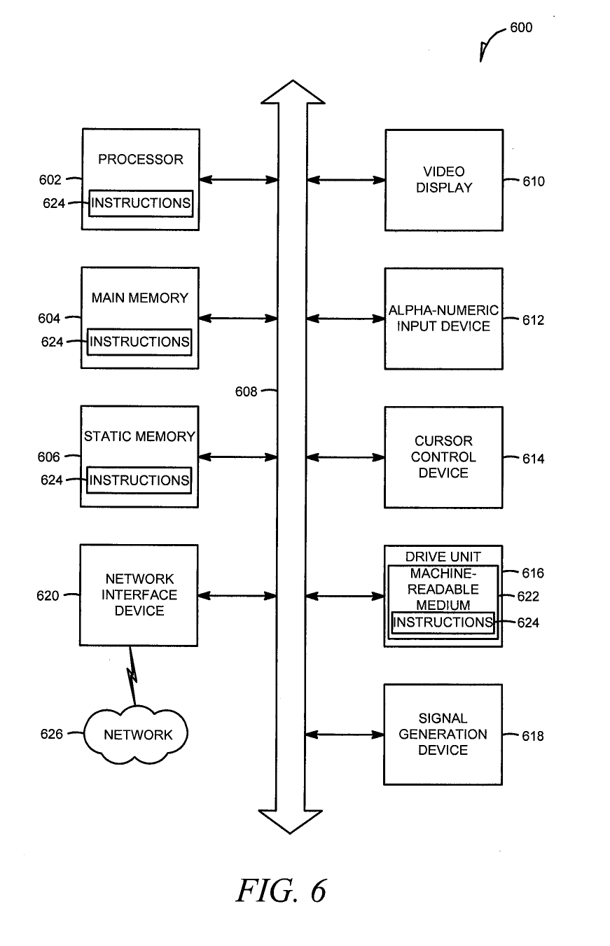

FIG. 6 shows a diagrammatic representation of machine in the example form of a computer system 600 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU) a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard or a touch screen), a cursor control device 614 (e.g., a mouse or a touch screen), a disk drive unit 616, a signal generation device 618 (e.g., a speaker) and a network interface device 620.

The disk drive unit 616 includes a machine-readable medium 622 on which is stored one or more sets of instructions (e.g., software 624) embodying any one or more of the methodologies or functions described herein. The software 624 may also reside, completely or at least partially, within the main memory 604 and/or within the processor 602 during execution thereof by the computer system 600, the main memory 604 and the processor 602 also constituting machine-readable media.

The software 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, non-transitory memories such as solid-state memories, and optical and magnetic media.

Thus, a method and system to provide a multi-quantity fixed price referral tool have been described. The method and system may be used to solve one or more technical problems such as reducing network traffic and improving data management. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

Embodiments of the multi-quantity fixed price referral methods may include a method comprising selecting a category from a catalogue hierarchy used by an online publication system, the selected category being one of a plurality of categories assigned to listings describing an item for sale; filtering listings within the selected category to select a set of filtered listings; applying a decay formula to each filtered listing of the set of filtered listings; selecting one or more of the filtered listings based on a ranking of the filtered listings; and providing a graphical user interface to a user of an online publication system, the graphical user interface to display the selected filtered listings to the user.

In some of the methods, the selecting of the selected category further comprises identifying a level one category within the catalogue hierarchy; identifying a level two category that is a child category of the level one category; determining if sales within the level two category meet a predefined threshold; if the predefined threshold is met, selecting the level two category but if the predefined threshold is not met, combining the level two category into the level one category.

In some embodiments, the filtering may be based on: an average price in the selected category, the distribution of prices within the category, and the number of items in the category; information in seller profiles; a format of the respective listings in the selected category; an expiration of the respective listings in the selected category; an available quantity of an item for sale described by the respective listing in the selected category; a number of items sold; an adjusted historical sales threshold; a total number of impressions of the listing; and/or a country from which the listing was received.

In some embodiments, the decay formula is applied to the number of sales of each filtered listing of the set of filtered listings and/or to the number of impressions of each filtered listing of the set of filtered listings.

In some embodiments, the ranking of the filtered listings is based on a number of sales per impression of the respective filtered listings, a characteristic of a buyer, and/or a characteristic of a seller.

Embodiments of the referral system may comprise a category module to select a category from a catalogue hierarchy used by an online publication system, where the selected category is one of a plurality of categories assigned to listings describing an item for sale; a filter module to filter listings within the selected category to select a set of filtered listings; a decay module to apply a decay formula to each filtered listing of the set of filtered listings; a ranking module to select one or more of the filtered listings based on a ranking of the filtered listings; and an interface module to provide a graphical user interface to a user of an online publication system, the graphical user interface to display the selected filtered listings to the user.

In some embodiments, the category module is further to identify a level one category within the catalogue hierarchy, identify a level two category that is a child category of the level one category, determine if sales within the level two category meet a predefined threshold, and, if the predefined threshold is met, select the level two category but if the predefined threshold is not met, combine the level two category into the level one category.

In some embodiments, the filter module includes a price filter, a seller filter, a format filter, a quantity filter, a sales filter, an impression filter, and a country filter.

In some embodiments, the decay module is to apply the decay formula to the number of sales of each filtered listing of the set of filtered listings and/or to the number of impressions of each filtered listing of the set of filtered listings.

In some embodiments, the ranking module is further to rank the filtered listings based on a number of sales per impression of the respective filtered listings, a characteristic of a buyer, and/or a characteristic of a seller.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
selecting a category from a catalogue hierarchy used by an online publication system, the selected category being one of a plurality of categories assigned to listings each describing an item for sale;
filtering listings within the selected category to select a set of filtered listings;
applying a decay formula to each filtered listing of the set of filtered listings;
selecting one or more of the filtered listings based on a ranking of the filtered listings; and
providing a graphical user interface to a user of an online publication system, the interface to display the selected filtered listings to the user.

2. The method of claim 1, wherein the selecting of the selected category further comprises:
identifying a level one category within the catalogue hierarchy;
identifying a level two category that is a child category of the level one category;
determining if sales within the level two category meet a predefined threshold; and
if the predefined threshold is met, preserving the level two category.

3. The method of claim 2, wherein the selecting of the selected category further comprises:
if the predefined threshold is not met, combining the level two category into the level one category.

4. The method of claim 1, wherein the filtering of the listings is based on an average price in the selected category, a distribution of prices within the selected category, and a number of items in the selected category.

5. The method of claim 1, wherein the filtering of the listings is based on information in seller profiles.

6. The method of claim 1, wherein the filtering of the listings is based on a format of each of the listings in the selected category.

7. The method of claim 1, wherein the filtering of the listings is based on an expiration time of each of the listings in the selected category.

8. The method of claim 1, wherein the filtering of the listings is based on an available quantity of items for sale described by each of the listings in the selected category.

9. The method of claim 1, wherein the filtering of the listings is based on a number of items sold.

10. The method of claim 9, wherein the filtering of the listings is based on a sales threshold.

11. The method of claim 1, wherein the filtering of the listings is based on a total number of impressions of each of the listings.

12. The method of claim 1, wherein the filtering of the listings is based on a country from which each of the listings was received.

13. The method of claim 1, wherein the decay formula is applied to the number of sales of each filtered listing of the set of filtered listings.

14. The method of claim 1, wherein the decay formula is applied to the number of impressions of each filtered listing of the set of filtered listings.

15. The method of claim 1, wherein the ranking of the filtered listings is based on a number of sales per impression of each of the filtered listings.

16. The method of claim 1, wherein the ranking of the filtered listings is based on a characteristic of a buyer or a characteristic of a seller.

17. A system comprising:
a category module to select a category from a catalogue hierarchy used by an online publication system, the selected category being one of a plurality of categories assigned to listings each describing an item for sale;
a filter module to filter listings within the selected category to select a set of filtered listings;
a decay module to apply a decay formula to each filtered listing of the set of filtered listings;
a ranking module to select one or more of the filtered listings based on a ranking of the filtered listings; and
an interface module to provide a graphical user interface to a user of an online publication system, the interface to display the selected filtered listings to the user.

18. The system of claim 17, wherein the category module is further to identify a level one category within the catalogue hierarchy, identify a level two category that is a child category of the level one category, determine if sales within the level two category meet a predefined threshold, and, if the predefined threshold is met, preserve the level two category.

19. The system of claim 18, wherein the category module is further to, if the predefined threshold is not met, combine the level two category into the level one category.

20. A non-transitory computer-readable medium having instructions embodied thereon, the instructions executable by one or more processors to perform a referral method, the referral method comprising:
selecting a category from a catalogue hierarchy used by an online publication system, the selected category being one of a plurality of categories assigned to listings each describing an item for sale;
filtering listings within the selected category to select a set of filtered listings;
applying a decay formula to each filtered listing of the set of filtered listings;
selecting one or more of the filtered listings based on a ranking of the filtered listings; and
providing a graphical user interface to a user of an online publication system, the interface to display the selected filtered listings to the user.
